(19) United States
(12) Patent Application Publication
(10) Pub. No.: US 2003/0106047 A1
(43) Pub. Date: Jun. 5, 2003

(54) Program conversion system and semiconductor device developing system

(75) Inventors: Toshio Nakano, Tokyo (JP); Tsuyoshi Yamada, Tokyo (JP); Yasushi Koseko, Tokyo (JP)

Correspondence Address: McDermott, Will & Emery, 600 13th Street, N.W., Washington, DC, 20005-3096, US

(73) Assignee: Mitsubishi Denki Kabushiki Kaisha

(21) Appl. No.: 10/159,023

(22) Filed: Jun. 3, 2002

(30) Foreign Application Priority Data
Dec. 5, 2001 (JP) 2001-371870

(51) Int. Cl. G06F 9/45

(52) U.S. Cl. 717/138

(57) ABSTRACT

A system in which a terminal of a program developer and a program conversion system are connected to each other via a network. The program conversion system is provided with a program sending/receiving device for sending a generated conversion destination program to and receiving a conversion source program from the terminal of the program developer, emulation devices corresponding to different conversion source programs, respectively, for generating intermediate-language programs by converting the conversion source programs, conversion devices corresponding to different conversion destination programs, respectively, for generating the conversion destination programs by converting the intermediate-language programs, a first selecting section for selecting one of the plurality of emulation devices, and a second selecting section for selecting one of the plurality of conversion devices.

### BACKGROUND OF THE INVENTION

1. Field of the Invention

The present invention relates to a program conversion system and a semiconductor device developing system. In particular, the invention relates to program conversion that is performed over a network.

2. Background Art

The production of a semiconductor device varies with time to a large extent. FIG. 9 schematically shows how production varies with time. In FIG. 9, the broken line indicates a production plan and the solid line indicates actual production results. As shown in FIG. 9, usually production results do not coincide with a production plan and vary with time to a large extent.

Examples of factors that cause a production result variation are a market situation, circumstances of customers, and a stock status of the company. For a manufacturing section of a maker, a production result variation means a manufacture load variation. When semiconductor device products are shipped, they are subjected to a prescribed test process using semiconductor testing apparatuses. The load of the semiconductor test process varies steeply with a manufacture load variation.

In a semiconductor test process, semiconductor testing apparatuses are allocated to semiconductor device products that have been produced according to a production plan. However, in practice, since the number of products increases and decreases greatly, each allocated semiconductor testing apparatus can rarely test products smoothly. To adjust a production plan and production results, that is, to accommodate a production result variation, semiconductor device makers entrust manufacture including semiconductor testing to an external vendor, distribute the loads of semiconductor testing apparatus owned by themselves, or take other measures.

One method for adjusting loads using semiconductor testing apparatus owned by a maker itself is to perform tests by diverting semiconductor testing apparatuses other than those being used in a current manufacturing process. Each of these semiconductor testing apparatuses operates according to a prescribed program. To apply semiconductor testing apparatuses being used in a current manufacturing process to a current manufacturing process, it is necessary to prepare new programs. Therefore, to make load adjustments by this method, it is necessary to prepare programs for semiconductor testing apparatuses early in time for shipment of semiconductor device products. The methods for preparing programs for semiconductor testing apparatuses include a method of generating programs by converting programs being used for current manufacture in addition to a method of generating new programs.

To introduce a new semiconductor testing apparatus and cause it to operate, it is necessary to check, by using semiconductor test programs for different kinds of semiconductor devices, whether the apparatus can be used properly in a factory or the like. To this end, it is necessary to prepare the semiconductor test programs.

However, the preparation of such semiconductor test programs has the following problems.

FIG. 10 schematically shows problems of conventional conversion of a semiconductor test program. The following description will be directed to a case of diverting a test program 101 for a testing apparatus A by converting it into a test program 104 for a testing apparatus B.

As shown in FIG. 10, there are two methods for converting a program: manual conversion 102 by an engineer and conversion 103 by a program conversion tool for a particular apparatus.

The manual conversion 102 by an engineer requires a highly skilled semiconductor test program developer who understands conversion source and destination semiconductor test program languages. Such a program developer needs to generate a program and check its operation and correlation with an existing semiconductor test program. This results in a problem that development of a program through conversion takes more time than that development of a new program. Further, it is necessary to secure a plurality of highly skilled semiconductor test program developers, which results in a problem that the personnel expenses increase and in turn the manufacturing cost increases.

On the other hand, in the conversion 103 using a program conversion tool for a particular apparatus, the test program 101 for the testing apparatus A is automatically converted into the test program 104 for the testing apparatus B by using a program conversion tool for a particular apparatus.

For example, a semiconductor device maker entrusts a software development company to develop such a program conversion tool or requests a semiconductor testing apparatus maker of a newly purchased semiconductor testing apparatus to generate such a program conversion tool as its attachment.

However, since a program conversion tool for a particular apparatus is not a general-purpose tool, it cannot be used for a different conversion destination semiconductor testing apparatus. It is necessary to develop a program conversion tool for a particular apparatus every time the conversion destination semiconductor testing apparatus is changed. This results in a problem that the program development cost increases as the number of conversion destination semiconductor testing apparatuses increases.

Further, to develop a program conversion tool for a particular apparatus, a software development company or a semiconductor testing apparatus maker needs to be familiar with the languages of conversion source and destination programs for a semiconductor testing apparatus. This results in a problem that development of a program conversion tool for a particular apparatus takes a half year or more. A long development time causes problems such as a delay of shipment of products.

As described above, with the conventional methods, it is difficult to produce a general-purpose semiconductor test program conversion tool and cost increase due to program conversion work cannot be avoided.

### SUMMARY OF THE INVENTION

The present invention has been made to solve the above problems in the art, and a first object of the invention is therefore to generate a program for a particular apparatus based on an existing program while minimizing a cost increase.

A second object of the invention is to perform program conversion in timely fashion using an existing program conversion tool.

According to one aspect of the present invention, a program conversion system connected to a terminal of a program developer via a network. The program conversion system comprises receiving means, a plurality of emulation means, a plurality of conversion means, first selecting means, second selecting means, and sending means. The receiving means is for receiving a conversion source program from the terminal of the program developer. A plurality of emulation means are corresponding to different conversion source programs respectively. The emulation means is for generating intermediate-language programs by converting the conversion source programs. A plurality of conversion means are corresponding to different conversion destination programs respectively. The conversion means is for generating the conversion destination programs by converting the intermediate-language programs. The first selecting means is for selecting one of the plurality of emulation means. The second selecting means is for selecting one of the plurality of conversion means. The sending means is for sending a generated conversion destination program to the terminal of the program developer.

According to another aspect of the present invention, a semiconductor device developing system comprises a terminal of a program developer or a semiconductor logic circuit designer; and a semiconductor device development assisting system of a semiconductor device development assisting party. The semiconductor device development assisting system is connected to the terminal of the program developer or the semiconductor logic circuit designer via a network. The semiconductor device development assisting system comprises receiving means, a plurality of emulation means, a plurality of conversion means, a plurality of logic circuit simulation means, first selecting means, second selecting means, third selecting means, and sending means. The receiving means is for receiving a conversion source program from the terminal of the program developer or the semiconductor logic circuit designer. A plurality of emulation means are corresponding to different conversion source programs respectively. The emulation means is for generating intermediate-language programs by converting the conversion source programs. A plurality of conversion means are corresponding to different conversion destination programs respectively. The conversion means is for generating the conversion destination programs by converting the intermediate-language programs. A plurality of logic circuit simulation means are corresponding to different logic circuits designed by the semiconductor logic circuit designer respectively. The logic circuit simulation means is for checking the logic circuits and generating simulation results. The first selecting means is for selecting one of the plurality of emulation means. The second selecting means is for selecting one of the plurality of conversion means. The third selecting means is for selecting one of the plurality of logic circuit simulation means. The sending means is for sending a generated conversion destination program or simulation result to the terminal of the program developer or the semiconductor logic circuit designer.

According to the present invention, an emulation device corresponding to a conversion source program is selected from a plurality of emulation devices and an intermediate-language program that is compatible with a plurality of conversion devices is generated by the selected emulation device. Highly versatile program conversion can be obtained by selecting one emulation device and one conversion device.

### BRIEF DESCRIPTION OF THE DRAWINGS

FIG. 1 schematically shows the configuration of a program generation system according to a first embodiment of the present invention.

FIG. 2 schematically shows a processing procedure of the program generation system according to the first embodiment.

FIG. 3 schematically shows parties who prepare and manage the terminal 1, the Web pages and the WWW server 3, the emulation devices 5a-5c, the conversion devices 6a-6c, the program sending/receiving device 4, and the intermediate language 7 in the program generation system according to the first embodiment.

FIG. 4 schematically shows a cash flow of the program generation system according to the first embodiment.

FIG. 5 schematically shows a cash flow in the second embodiment.

FIG. 6 schematically shows the configuration of a semiconductor device developing system according to the third embodiment.

FIG. 7 shows parties who prepare and manage the devices etc. of the semiconductor device development assisting system 22 in the third embodiment.

FIG. 8 schematically shows a cash flow in the third embodiment.

FIG. 9 schematically shows how production varies with time.

FIG. 10 schematically shows problems of conventional conversion of a semiconductor test program.

### DETAILED DESCRIPTION OF THE PREFERRED EMBODIMENTS

First Embodiment

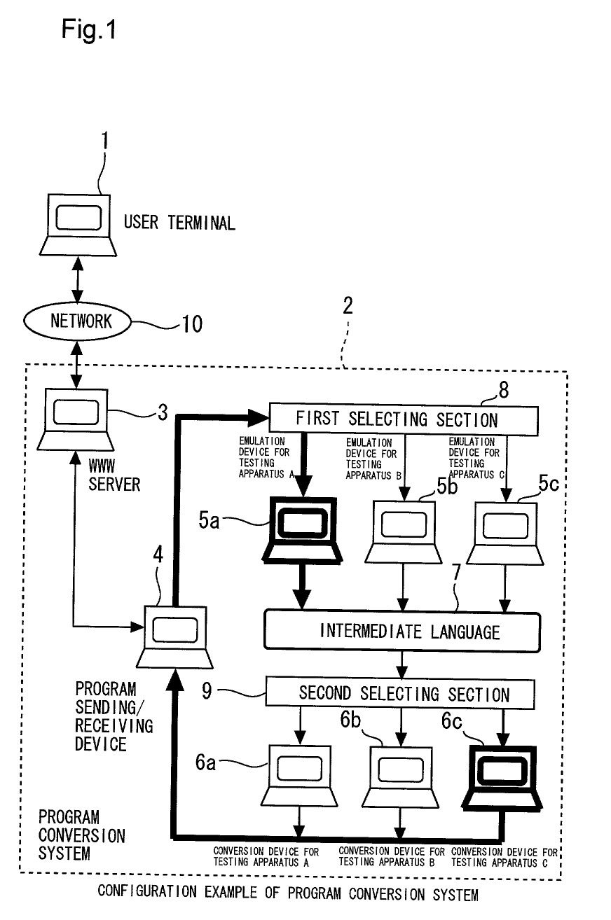

FIG. 1 schematically shows the configuration of a program generation system according to a first embodiment of the present invention. In this program generation system, a user terminal 1 that is held by a developer of a program for a semiconductor testing apparatus (semiconductor test program developer) as a user and a program conversion system 2 that is held by a program conversion company are connected to each other via a network 10 such as the Internet. In this program generation system, the program conversion company generates a program for another semiconductor testing apparatus (i.e., a conversion destination program) by converting a program for a particular semiconductor testing apparatus (i.e., a conversion source program).

The program conversion system 2 of the program conversion company is composed of a WWW server 3, a program sending/receiving device 4, emulation devices 5a, 5b, and 5c for various semiconductor testing apparatuses, conversion devices 6a, 6b, and 6c, a first selecting section 8, and a second selecting section 9.

The user terminal 1 is connected to the WWW server 3 via the network 10. The user terminal 1 is a workstation, a personal computer, or the like. The semiconductor test program developer as a user develops a semiconductor test program using the terminal 1, browses Web pages, sends and receives a semiconductor test program, and does other operations. The program developer may perform these operation using different terminals. Web pages provided by the program conversion company are sent from the WWW server 3 to the terminal 1. Information on conversion source programs and conversion destination programs that can be handled by the program conversion company, information on semiconductor testing apparatuses that are compatible with those programs, and other information are displayed on the Web pages. The program developer can send and receive such information to and from the program conversion system 2 through the Web pages, and can specify a conversion source program or a conversion source program displayed on a Web page.

The program sending/receiving device 4 is connected to the WWW server 3. Information received by the WWW server 3 over the network 10 is supplied to the program sending/receiving device 4. Information received by the program sending/receiving device 4 is supplied to the emulation devices 5a-5c via the first selecting section 8.

Each of the emulation devices 5a-5c generates an intermediate-language program that is necessary for program conversion based on a conversion source program specified by the program developer. To accommodate various conversion source programs, the program conversion system 2 is provided with the plurality of emulation devices 5a-5c.

Based on an instruction from the terminal 1, the first selecting section 8 selects one of the emulation devices 5a-5c that is suitable for a conversion source program. As indicated by thick-line arrows in FIG. 1, it is assumed here that the emulation device 5a is selected.

Each of the conversion devices 6a-6c of the program conversion system 2 generates a conversion destination program based on an intermediate-language program generated by one of the emulation devices 5a-5c. The conversion destination program is a program to be used for a semiconductor testing apparatus that the program developer intends to use. Based on an instruction from the terminal 1, the second selecting section 9 selects one of the conversion devices 6a-6c that is suitable for the conversion destination program. As indicated by thick-line arrows in FIG. 1, it is assumed here that the conversion device 6c is selected.

The first selecting section8 and the second selecting section 9 may be either separate pieces of hardware or a single piece of hardware that is also integral with the program sending/receiving device 4.

By generating a test program based on an intermediate-language program generated by one of the emulation devices 5a-5c, the program developer need not generate a test program from the first and hence can reduce the cost of conversion work. Since the intermediate language 7 can be used for conversion by all the conversion devices 6a-6c, the generation of an intermediate-language program enables program conversion that is highly versatile.

Timely program conversion can be realized by providing a use environment by publicizing, on the Web pages, existing tools such as semiconductor testing apparatuses for which conversion source programs and conversion destination programs are used.

A conversion destination program generated by one of the conversion devices 6a-6c is supplied to the program sending/receiving device 4 and then sent to the terminal 1 via the WWW server 3.

As described above, the program developer can freely select from the emulation devices 5a-5c and from the conversion devices 6a-6c based on the information on conversion source programs and conversion destination programs that is displayed on the Web pages. The program developer can freely select from the emulation devices 5a-5c and from the conversion devices 6a-6c using intermediate-language programs generated by the emulation devices 5a-5c.

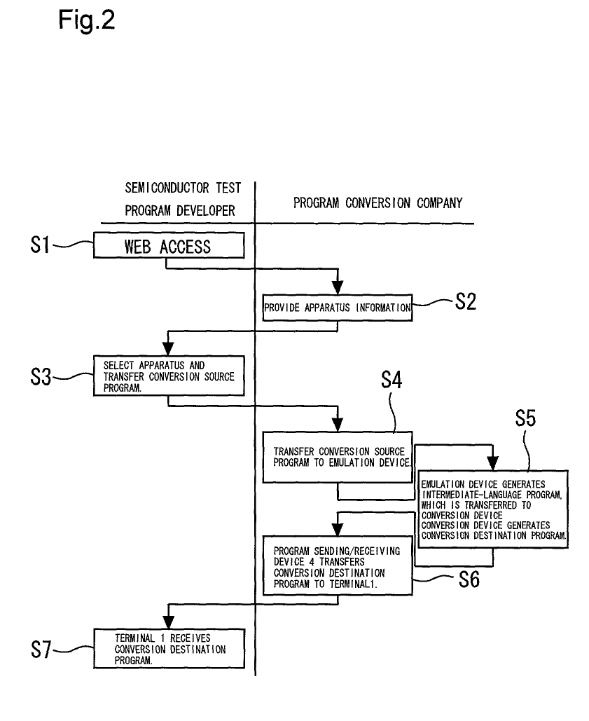

Next, a program conversion process according to the first embodiment will be described with reference to FIG. 2. FIG. 2 schematically shows a processing procedure of the program generation system according to the first embodiment.

First, at step S1, the semiconductor test program developer accesses Web pages provided for the terminal 1, over the network 10. The Web pages are prepared by the program conversion company.

At step S2, information on programs that are used by various semiconductor testing apparatuses is provided from the program conversion system 2 of the program conversion company to the semiconductor test program developer. Specifically, information on currently usable conversion source programs and conversion destination programs and information on various semiconductor testing apparatuses that use those programs are transferred from the program conversion company to the terminal 1 of the program developer through the Web pages.

At step S3, based on the information transferred at step S2, the program developer a conversion source program and a conversion destination program that the program developer is going to use or the name of a semiconductor testing apparatus corresponding to those programs is selected on the Web pages. At the same time, the program developer transfers a conversion source program held by itself to the program sending/receiving device 4 of the program conversion system 2. It is assumed that the conversion source program is transferred while strict security is maintained.

At step S4, the program sending/receiving device 4 transfers, to the emulation device concerned, the semiconductor test program that was received at step S3. In this embodiment, as shown in FIG. 1, the conversion source program is supplied to the emulation device 5a corresponding to the semiconductor testing apparatus selected by the program developer.

At step S5, the emulation device 5a generates an intermediate-language program based on the semiconductor test program transferred at step S4. Then, the intermediate-language program is transferred to the conversion device specified by the program developer. In this embodiment, as shown in FIG. 1, it is assumed that the program developer selected the conversion device 6c.

The conversion device 6c receives the intermediate-language program and generates a conversion destination program for the semiconductor testing apparatus specified by the program developer. To return the generated conversion destination program to the program developer, the conversion device 6c transfers it to the program sending/receiving device 4.

At step S6, the program sending/receiving device 4 returns the conversion destination program to the terminal 1 of the program developer. At step S7, the terminal 1 of the program developer receives the conversion destination program.

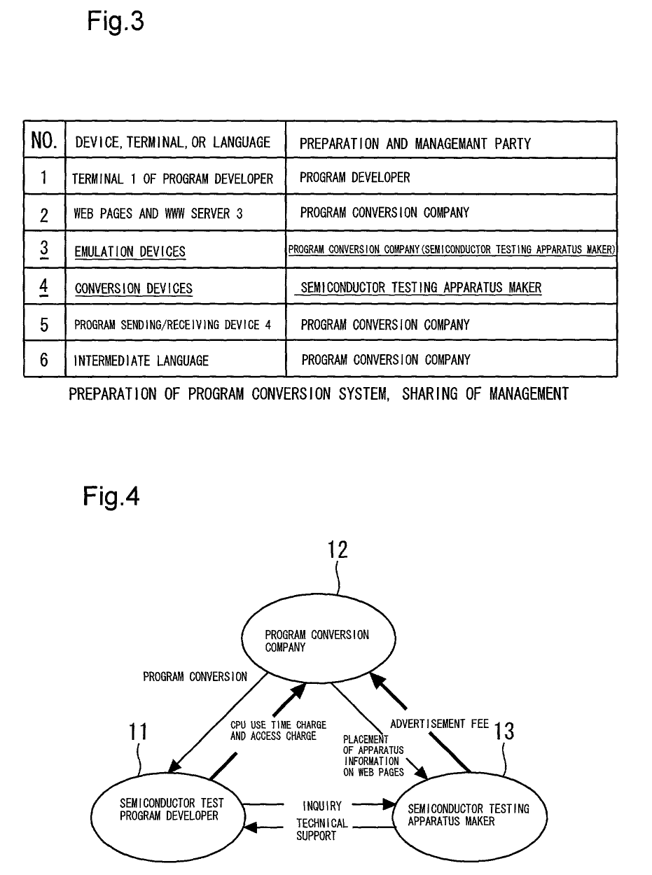

FIG. 3 schematically shows parties who prepare and manage the terminal 1, the Web pages and the WWW server 3, the emulation devices 5a-5c, the conversion devices 6a-6c, the program sending/receiving device 4, and the intermediate language 7 in the program generation system according to the first embodiment.

As shown in FIG. 3, the terminal 1 is prepared and managed by the semiconductor test program developer. The Web pages and the WWW server 3 are prepared and managed by the program conversion company. The emulation devices 5a-5c are basically prepared and managed by the program conversion company. As an exception, they may be prepared and managed by a semiconductor testing apparatus maker. The conversion devices 6a-6c are prepared and managed by the semiconductor testing apparatus maker. The program sending/receiving device 4 and the intermediate language 7 are prepared and managed by the program conversion company.

The parties who prepare and manage the conversion devices 6a-6c and the emulation devices 5a-5c are most important.

As shown in FIG. 3, the conversion devices 6a-6c are developed (prepared) and managed by the semiconductor testing apparatus maker. The conversion devices 6a-6c are thereafter supplied to the program conversion company. As sales promotion, the semiconductor testing apparatus maker requests the program conversion company to publicize the conversion devices 6a-6c on the Web pages.

That is, to increase the versatility of its own semiconductor testing apparatuses and impress users with their advantages, the semiconductor testing apparatus maker develops the conversion devices 6a-6c that convert an intermediate-language program into programs for its own semiconductor testing apparatuses.

There may be a case that when a semiconductor maker purchases a semiconductor testing apparatus, the semiconductor maker requests, as a condition for purchase, that conversion into a program to be used by the semiconductor testing apparatus be performed easily. The versatility of semiconductor testing apparatuses of the semiconductor testing apparatus maker is increased by developing the conversion devices 6a-6c that are compatible with the intermediate language 7 of the program conversion system 2. The program developer of the semiconductor maker can recognize, in advance, information relating to program conversion such as whether a semiconductor testing apparatus that the semiconductor makes is going to purchase is accompanied by a conversion device by referring the Web pages from the terminal 1. Therefore, the semiconductor apparatus maker can promote the sale of the semiconductor testing apparatuses by developing the conversion devices 6a-6c, supplying those to the program conversion company, and having their information displayed on the Web pages of the program conversion company. That is, the semiconductor testing apparatus maker can promote the sale of the semiconductor testing apparatuses by increasing their versatility by developing the conversion devices 6a-6c.

Even after publicizing the information on the semiconductor testing apparatuses on the Web pages, the semiconductor testing apparatus maker maintains, when necessary, the conversion devices 6a-6c that were supplied to the program conversion company.

The relationship between the emulation devices 5a-5c and the semiconductor testing apparatus maker is relatively weak. Therefore, the emulation devices 5a-5c are developed by the program conversion company alone or by the program conversion company with assistance from the semiconductor testing apparatus maker. It is appropriate for the program conversion company to consult, when necessary, with the semiconductor testing apparatus maker who is familiar with specifications of semiconductor test programs.

As for the maintenance of the emulation devices 5a-5c, the program conversion company receives version-up information of the specifications of the semiconductor testing apparatuses and causes the emulation devices 5a-5c to reflect it.

Next, a cash flow in the first embodiment will be described with reference to FIG. 4. FIG. 4 schematically shows a cash flow of the program generation system according to the first embodiment. In FIG. 4, thick-line arrows indicate flows of money. The program conversion company 12 provides, on the Web pages, the information on the semiconductor testing apparatuses and the conversion devices 6a-6c that were developed by the semiconductor testing apparatus maker 13. The semiconductor testing apparatus maker 13 pays an advertisement fee to the program conversion company 12 for the placement of the above information on the Web pages.

The program conversion company 12 supplies a conversion destination program to the semiconductor test program developer 11 through the Web pages displayed on the terminal 1. The program conversion company 12 collects a CPU use fee and a technical service fee of the conversion to the program developer 11 for the supply of the conversion destination program. The sum of money collected in this manner is set at ⅕ to 1/10 of a development cost of a program conversion tool dedicated to a particular apparatus. This prevents a user from daring to develop a program dedicated to a particular apparatus, and can thereby promote the use of the system according to the embodiment. The program conversion company 11 can recover the cost of generation of a program by collecting fees for the supply of the program in the above-described manner.

As described above, the first embodiment makes it unnecessary to develop a program conversion tool for a particular semiconductor testing apparatus and hence can reduce the cost of conversion work on the program developer side.

Timely program conversion in response to a request from the program developer can be realized by providing a use environment by publicizing, on the Web pages, existing tools such as conversion source programs and conversion destination programs.

The semiconductor testing apparatus maker can increase the versatility of the semiconductor testing apparatuses and enhance the advertisement effect on users by enriching the conversion devices 6a-6c, and can thereby increase the sales of the semiconductor testing apparatuses.

The program conversion company can recover the cost of the generation of a program by collecting a CPU use fee and a technical service fee.

Further, the program conversion company can acquire, via the terminal 1, such information as requests of the program developer about the semiconductor testing apparatuses. The program conversion company can provide, for pay, information acquired in this manner to the semiconductor testing apparatus maker.

Second Embodiment

A second embodiment is directed to a case that the semiconductor test program developer investigates a semiconductor testing apparatus he is going to purchase using the program generation system according to the first embodiment, and judges whether to purchase it.

Whereas the configuration of the program generation system and the flow of program conversion are the same as in the first embodiment, the cash flow is different than in the first embodiment.

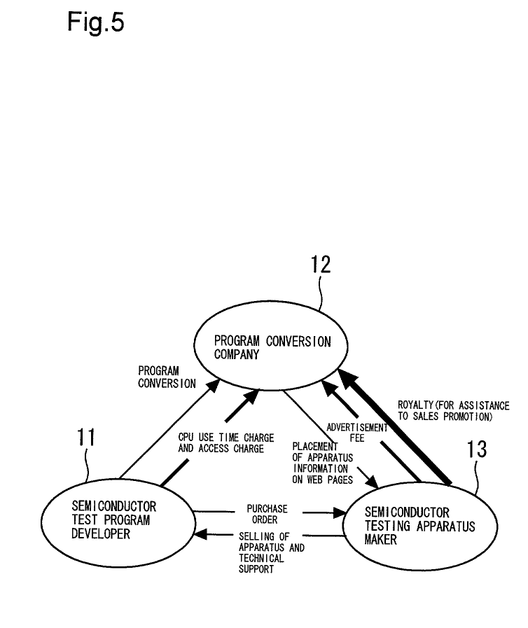

In the second embodiment, the semiconductor test program developer uses the program generation system to collect information in purchasing a semiconductor testing apparatus. FIG. 5 schematically shows a cash flow in the second embodiment. The program developer 11 who plans to purchase a semiconductor testing apparatus performs program conversion using the system according to the first embodiment before purchasing it. The program developer 11 can judge whether to buy the semiconductor testing apparatus based on results of the program conversion. For example, if a conversion source program owned by the program developer 11 cannot be converted into a program suitable for the semiconductor testing apparatus concerned or if desired functions cannot be obtained though conversion is possible, the program developer 11 can refrain from purchasing the semiconductor testing apparatus. If the program developer 11 has decided to purchase the semiconductor testing apparatus, the program developer 11 sends information to that effect to the semiconductor testing apparatus maker 13.

The semiconductor testing apparatus maker 13 who has received the order for the semiconductor testing apparatus sells it to the program developer 11. In this case, the program conversion company 12 has contributed to the sales promotion through the use of the program conversion system, the placement of an advertisement of the Web pages, etc. Therefore, in the cash flow of the second embodiment shown in FIG. 5, royalty payment by the semiconductor testing apparatus maker 13 to the program conversion company 12 is added to the cash flow of the first embodiment.

According to the second embodiment, the semiconductor test program developer can experience, before purchasing a semiconductor testing apparatus, how program conversion support is made after purchase of it. Therefore, the program developer can extract problems of program conversion at an early stage.

The semiconductor testing apparatus maker can notify the program developer as a user about easiness of reception of program conversion support, which means increased sales promotion for the semiconductor testing apparatus.

Third Embodiment

A third embodiment is such that a semiconductor device developing system is constructed by adding, to the functions of the program generation system according to the first embodiment, a function that allows a program developer to develop a semiconductor test program or use devices that are used in semiconductor circuit designing on Web pages. In this embodiment, a program developer can also use, on Web pages, a logic circuit simulation device that is necessary for a circuit check in semiconductor circuit designing.

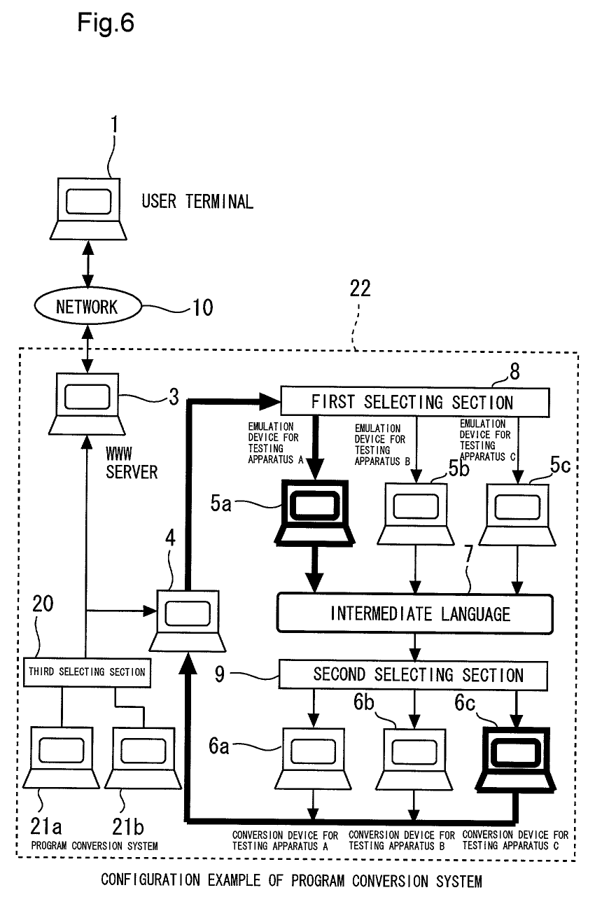

FIG. 6 schematically shows the configuration of a semiconductor device developing system according to the third embodiment. As shown in FIG. 6, in the semiconductor device developing system according to the third embodiment, a terminal 1 that is held by a developer of a program for a semiconductor testing apparatus or a semiconductor logic circuit designer as a user and a semiconductor device development assisting system 22 that is held by a semiconductor development assisting company are connected to each other via a network 10 such as the Internet. In this embodiment, a third selecting section 20 and logic circuit simulation devices 21a and 21b are added to the program generation system according to the first embodiment. The other part of the configuration is the same as in the first embodiment.

The semiconductor logic circuit designer accesses Web pages that are provided by the semiconductor development assisting company over the network 10. The semiconductor logic circuit designer can choose one of the logic circuit simulation devices 21a and 21b that is necessary for logic circuit designing. The semiconductor logic circuit designer can check a designed logic circuit by using the selected logic circuit simulation device. Choosing between the logic circuit simulation devices 21a and 21b is performed by the third selecting section 20 according to an instruction from the semiconductor logic circuit designer. The third selecting section may be a separate piece of hardware or be integral with the program sending/receiving device 4.

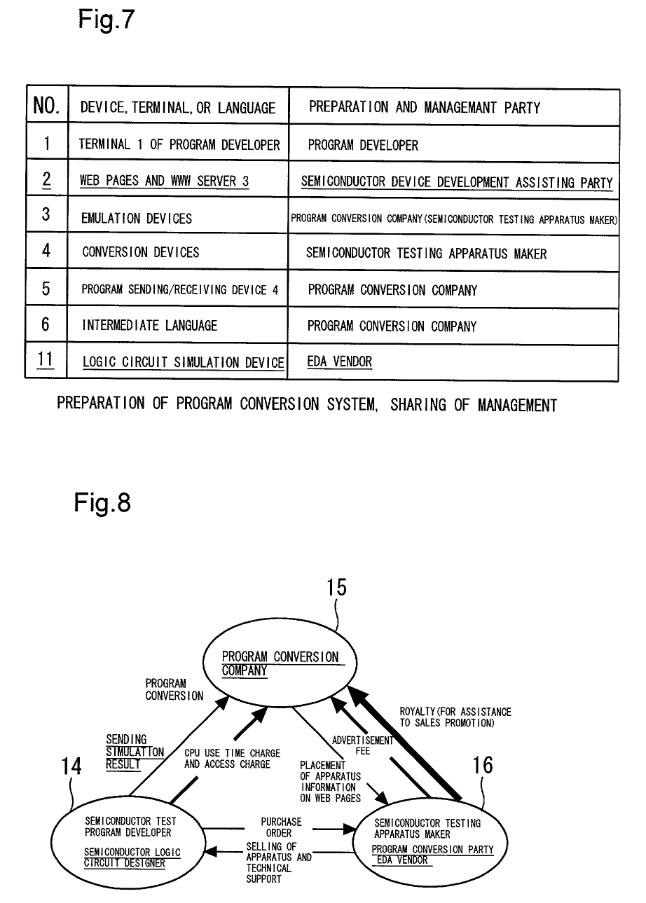

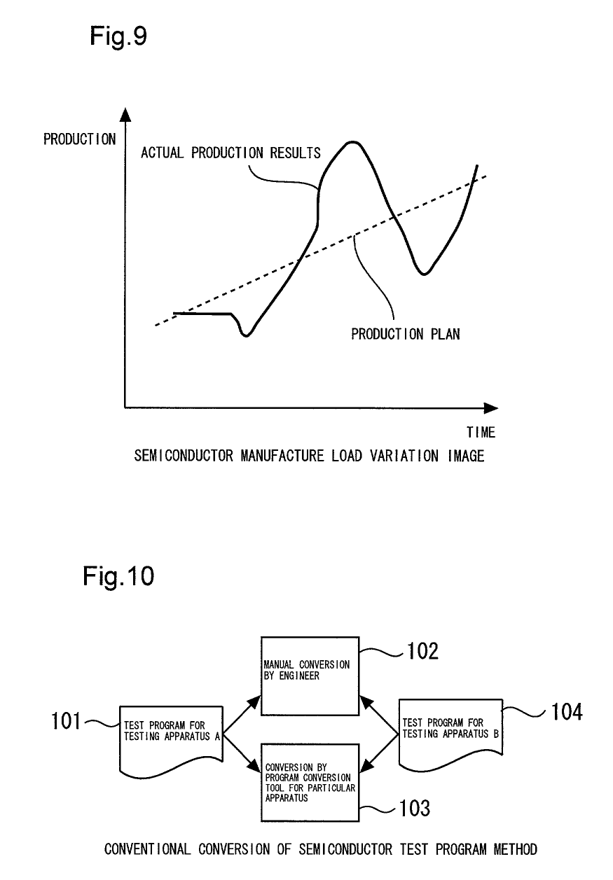

FIG. 7 shows parties who prepare and manage the devices etc. of the semiconductor device development assisting system 22 in the third embodiment. Differences from the case of the first embodiment shown in FIG. 3 are as follows. In the first embodiment, the program conversion company prepares and manages the Web pages and the WWW server 3. In the third embodiment, the logic circuit simulation devices 21a and 21b that are necessary for a circuit check of semiconductor circuit designing can be used on the Web, and it is expected that only the knowledge of semiconductor tests is not enough to prepare and manage the Web pages and the WWW server 3. In view of this, in the third embodiment, the Web pages and the WWW server 3 are prepared and managed by the semiconductor development assisting company. The logic circuit simulation devices 21a and 21b that are newly provided are prepared and managed by an EDA vendor. The logic circuit simulation devices 21a and 21b themselves are supplied to the semiconductor development assisting company.

FIG. 8 schematically shows a cash flow in the third embodiment. This cash flow is such that a cash flow relating to use of the logic circuit simulation devices 21a and 21b is added to the cash flow of the first embodiment shown in FIG. 4.

Specifically, the semiconductor development assisting company 15 collects an advertisement fee and a royalty (when a sales contract of an apparatus concerned is made) from an apparatus vendor 16 such as an EDA vendor or a semiconductor testing apparatus maker for sales promotion through publicizing of information on semiconductor testing apparatuses and the logic circuit simulation devices 21a and 21b.

As described above, according to the third embodiment, the designer 14 such as a program developer or a semiconductor logic circuit designer can perform not only program conversion but also logic circuit simulation suitable for a designing environment (by choosing between the logic circuit simulation devices 21a and 21b).

The apparatus vendor 16 such as a semiconductor testing apparatus maker or an EDA vendor can enrich the emulation devices 5a-5c and the logic circuit simulation devices 21a and 21b and can thereby increase the sales of its products such as the semiconductor testing apparatuses and the logic circuit simulation devices 21a and 21b. By having apparatus information placed on the Web pages of the semiconductor development assisting company 15, the apparatus vendor 16 can enhance the advertisement effect.

The semiconductor development assisting company 15 can collect a CPU use fee and a technical service fee from the designer 14 such as a program developer or a semiconductor logic circuit designer.

The semiconductor development assisting company 15 can collect an advertisement fee and a royalty from the apparatus vendor 16 such as a semiconductor testing apparatus maker or an EDA vendor for the placement of the apparatus information on the Web pages.

Further, the semiconductor development assisting company 15 can acquire such information as specifications requested by the designer 14 such as a program developer or a semiconductor logic circuit designer, and can provide, for pay, the acquired information to a program conversion company and the apparatus vendor 16 such as a semiconductor testing apparatus maker or an EDA vendor.

As described above, the processing procedure according to each of the above embodiments can be implemented by the hardware that is held by the program conversion system 2 or the semiconductor device development assisting system 22. The program conversion system 2 or the semiconductor device development assisting system 22 may be implemented by a single computer. In this case, each function block and processing step of the program conversion system 2 or the semiconductor device development assisting system 22 is implemented by a microcomputer system including a CPU or MPU, a ROM, and a RAM (not shown) that are held by the computer and its operation is realized by a task program stored in the ROM or RAM. The task programs may be provided separately from the computer and a medium on which the task programs are stored may be mounted in a mounting unit of the computer.

The invention encompasses an implementation in which software programs for realizing the functions of the respective function blocks are supplied to the RAM of a computer and the function blocks are caused to operate according to those programs. In this case, the software programs themselves realize the functions of each of the above embodiments, and the programs themselves and means for supplying the programs to the computer such as a recording medium in which the programs are stored constitute the invention.

The invention as described above provides the following advantages.

An emulation device corresponding to a conversion source program is selected from a plurality of emulation devices and an intermediate-language program that is compatible with a plurality of conversion devices is generated by the selected emulation device. Highly versatile program conversion can be obtained by selecting one emulation device and one conversion device.

Since information on conversion source programs and conversion destination programs that can be subjected to or produced by program conversion is placed on Web pages, a program developer can select a desired conversion source program and conversion destination program.

Since each of a conversion source program and a conversion destination program are a program for causing a particular semiconductor testing apparatus to operate, a program for another semiconductor testing apparatus can be generated based on a program for an existing semiconductor device. This makes it possible to select, as appropriate, testing apparatuses to be used in a semiconductor test process based on production results of semiconductor devices and thereby increase their yields.

Information of a semiconductor testing apparatus for which a conversion source program and a conversion destination program are used may be placed on Web pages as information on those programs. In this case, a program developer or a semiconductor logic circuit designer can perform program conversion based on the information on the semiconductor testing apparatus.

By supplying a plurality of conversion devices to a program conversion company, a semiconductor testing apparatus maker can increase the versatility of its own semiconductor testing apparatuses and promote their sales.

Where logic circuit simulation devices for checking a plurality of logic circuits and produce simulation results are provided, a semiconductor logic circuit designer can check a desired logic circuit as well as perform program conversion.

Where information on logic circuits that can be checked is placed on Web pages, a semiconductor logic circuit designer can select and check a desired logic circuit.

Beside the claimed invention, the present invention includes various aspects as described above and summarized as follows.

According to one aspect of the present invention, there is provided a program conversion method using a program generation system in which a terminal of a program developer and a program conversion system of a program conversion party are connected to each other via a network. The method comprises the following steps. The program developer terminal sends information on a conversion source program and a conversion destination program to the program conversion system. The program conversion system selects emulation means suitable for the conversion source program. The program conversion system generates an intermediate-language program by converting the conversion source program using the selected emulation means. The program conversion system selects conversion means suitable for the conversion destination program. The program conversion system generates a conversion destination program based on the intermediate-language program using the selected conversion means. The program conversion system sends the generated conversion destination program to the terminal of the program developer.

According to another aspect of the present invention, the program conversion method described above, further comprises the following steps. Before the sending step executed by the program developer terminal, the step of the program conversion system places, on Web pages, information on conversion source programs and conversion destination programs that can be subjected to or produced by program conversion, and sends the information to the terminal of the program developer.

According to another aspect of the present invention, the program conversion method described above, each of the conversion source program and the conversion destination program is a program for causing a particular semiconductor testing apparatus to operate.

According to another aspect of the present invention, the program conversion method described above, each of the conversion source programs and the conversion destination programs is a program for causing a particular semiconductor testing apparatus to operate. The information on the conversion source programs and the conversion destination programs is information on the semiconductor testing apparatuses.

According to another aspect of the present invention, there is provided a computer-readable recording medium on which a program for causing a computer to execute the steps of the program conversion method described above.

According to another aspect of the present invention, a program causes a program conversion system to operate in a program generation system in which a terminal of a program developer and the program conversion system are connected to each other via a network. The program causes a computer to function as following. Receiving means is for receiving a conversion source program from the terminal of the program developer. A plurality of emulation means corresponds to different conversion source programs, respectively, the emulation means generates intermediate-language programs by converting the conversion source programs. A plurality of conversion means corresponds to different conversion destination programs respectively, the conversion means generates the conversion destination programs by converting the intermediate-language programs. First selecting means is for selecting one of the plurality of emulation means. Second selecting means is for selecting one of the plurality of conversion means. Sending means is for sending a generated conversion destination program to the terminal of the program developer.

Obviously many modifications and variations of the present invention are possible in the light of the above teachings. It is therefore to be understood that within the scope of the appended claims the invention may by practiced otherwise than as specifically described.

The entire disclosure of a Japanese Patent Application No. 2001-371870, filed on Dec. 5, 2001 including specification, claims, drawings and summary, on which the Convention priority of the present application is based, are incorporated herein by reference in its entirety.

1. A program conversion system connected to a terminal of a program developer via a network, comprising:
receiving means for receiving a conversion source program from said terminal of the program developer;
a plurality of emulation means corresponding to different conversion source programs, respectively, for generating intermediate-language programs by converting said conversion source programs;
a plurality of conversion means corresponding to different conversion destination programs, respectively, for generating said conversion destination programs by converting said intermediate-language programs;
first selecting means for selecting one of said plurality of emulation means;
second selecting means for selecting one of said plurality of conversion means; and
sending means for sending a generated conversion destination program to said terminal of the program developer.

2. The program conversion system according to claim 1, wherein the program conversion system further comprises server means for placing, on Web pages, information on said conversion source programs and said conversion destination programs that can be subjected to or produced by program conversion, and for sending said information to said terminal of the program developer.

3. The program conversion system according to claim 1, wherein each of said conversion source programs and said conversion destination programs is a program for causing a particular semiconductor testing apparatus to operate.

4. The program conversion system according to claim 2, wherein each of said conversion source programs and said conversion destination programs is a program for causing a particular semiconductor testing apparatus to operate, and wherein said information on said conversion source programs and said conversion destination programs is information on said semiconductor testing apparatuses.

5. The program conversion system according to claim 3, wherein said plurality of conversion means correspond to said respective semiconductor testing apparatuses that are different from each other, and said plurality of conversion means are supplied from a manufacturer of said semiconductor testing apparatuses.

6. A semiconductor device developing system comprising:
a terminal of a program developer or a semiconductor logic circuit designer; and
a semiconductor device development assisting system of a semiconductor device development assisting party, said semiconductor device development assisting system being connected to said terminal of the program developer or the semiconductor logic circuit designer via a network, said semiconductor device development assisting system comprising:
receiving means for receiving a conversion source program from said terminal of the program developer or the semiconductor logic circuit designer;
a plurality of emulation means corresponding to different conversion source programs, respectively, for generating intermediate-language programs by converting said conversion source programs;
a plurality of conversion means corresponding to different conversion destination programs, respectively, for generating said conversion destination programs by converting said intermediate-language programs;
a plurality of logic circuit simulation means corresponding to different logic circuits designed by said semiconductor logic circuit designer, respectively, for checking said logic circuits and generating simulation results;
first selecting means for selecting one of said plurality of emulation means;
second selecting means for selecting one of said plurality of conversion means;
third selecting means for selecting one of said plurality of logic circuit simulation means; and
sending means for sending a generated conversion destination program or simulation result to said terminal of said program developer or said semiconductor logic circuit designer.

7. The semiconductor device developing system according to claim 6, wherein said semiconductor development assisting system further comprises server means for placing, on Web pages, information on said conversion source programs and said conversion destination programs that can be subjected to or produced by program conversion or information on said logic circuits that can be checked, and for sending said information to said terminal of the program developer of the semiconductor logic circuit designer.

8. The semiconductor device developing system according to claim 6, wherein each of said conversion source programs and said conversion destination programs is a program for causing a particular semiconductor testing apparatus to operate.

9. The semiconductor device developing system according to claim 8, wherein said plurality of conversion means correspond to said respective semiconductor testing apparatuses that are different from each other, and said plurality of conversion means are supplied from a manufacturer of said semiconductor testing apparatuses.
